(19) United States
(12) Patent Application Publication
(10) Pub. No.: US 2026/0326077 A1
(43) Pub. Date: Oct. 22, 2026

(54) FUNCTIONALIZED LIMESTONE WITH ANTIMICROBIAL PROPERTIES AND FOR HEAVY METALS AND PHOSPHATE REMOVAL FOR WASTEWATER TREATMENT APPLICATIONS

(71) Applicants: HAMAD BIN KHALIFA UNIVERSITY, Doha (QA); QATAR FOUNDATION FOR EDUCATION, SCIENCE AND COMMUNITY DEVELOPMENT, Doha (QA)

(72) Inventors: Rashad A. Al-Gaashani, Doha (QA); Viktor Kochkodan, Doha (QA); Jenny Lawler, Doha (QA)

(21) Appl. No.: 19/099,594

(22) PCT Filed: Aug. 4, 2023
(86) PCT No.: PCT/QA2023/050015

§ 371 Date: Jan. 29, 2025

Related U.S. Application Data
(60) Provisional application No. 63/395,535, filed on Aug. 5, 2022.

(51) Int. Cl. B01J 20/04; B01J 20/28; B01J 20/32

(52) U.S. Cl. CPC B01J 20/043; B01J 20/28059; B01J 20/3225; B01J 20/3236; B01J 2220/46; B01J 2220/4806

(57) ABSTRACT

A method of manufacturing a functionalized composite includes mixing a precursor of at least one of zinc, iron, and copper with a precursor of silver to form a mixture solution, applying the mixture solution on limestone such that the limestone is saturated with the mixture solution, and heating the saturated limestone at a predetermined temperature for a predetermined amount of time to form a functionalized limestone doped with silver and at least one of zinc oxide, iron oxide, and copper oxide.

### CROSS-REFERENCE TO RELATED APPLICATION

The present application claims priority to U.S. Provisional Application No. 63/395,535 filed Aug. 5, 2022, and entitled “FUNCTIONALIZED LIMESTONE WITH ANTIMICROBIAL PROPERTIES AND FOR HEAVY METALS AND PHOSPHATE REMOVAL FOR WASTEWATER TREATMENT APPLICATIONS,” the disclosure of which is incorporated by reference herein in its entirety.

### BACKGROUND

Limestone (LS) material is a cheap and non-toxic stone mineral that abundantly exists in nature worldwide. Limestone is defined as (calcium carbonate) or dolomite (calcium magnesium carbonate) and it is widely available in nature and cost-effective in comparison with other adsorbent materials. LS is an alternative to lime for water treatment in drinking water plants. It has many applications for water treatment, such as the removal of sulfate from mine drainages and waste water, eliminating silica, improving the quality of drinking water in terms of softening, purifying and removing its impurities, neutralizing its acidity improving in the taste, smell and colour of drinking water.

### SUMMARY

The present disclosure generally relates to a functionalized limestone with antimicrobial properties, and for heavy metals and phosphate removal for wastewater treatment applications.

In light of the present disclosure, and without limiting the scope of the disclosure in any way, in an aspect of the present disclosure, which may be combined with any other aspect listed herein unless specified otherwise, a method for manufacturing a functionalized composite is provided. The method may include mixing a precursor of at least one of zinc, iron, and copper with a precursor of silver to form a mixture solution, applying the mixture solution on limestone such that the limestone is saturated with the mixture solution, and heating the saturated limestone at a predetermine temperature for a predetermined amount of time to form a functionalized limestone doped with silver and at least one of zinc oxide, iron oxide, and copper oxide.

Additional features and advantages of the disclosed systems and methods are described in, and will be apparent from, the following Detailed Description and the Figures.

### BRIEF DESCRIPTION OF THE FIGURES

FIG. 1 is a flowchart illustrating an example method for manufacturing a functionalized composite according to an example of the present disclosure.

FIG. 2 is a table summarizing the textural properties of raw limestone before doping and limestone doped with ZnO, CuO, Fe₂O₃ and Ag.

FIG. 3 is a graph showing the removal of heavy metals (As, Be, Cd, Cr, Ni, Pb, Se and Tl) from polycomponent solution with raw limestone.

FIG. 4. is a graph showing the removal of heavy metals (As, Be, Cd, Cr, Ni, Pb, Se and Tl) from polycomponent solution with limestone doped with CuO and Ag.

FIG. 5. is a graph showing the removal of heavy metals (As, Be, Cd, Cr, Ni, Pb, Se and Tl) from polycomponent solution with limestone doped with ZnO and Ag.

FIG. 6. is a graph showing the removal of heavy metals (As, Be, Cd, Cr, Ni, Pb, Se and Tl) from polycomponent solution with limestone doped with Fe₂O₃ and Ag.

FIG. 7. is a graph showing the effect of dose on the removal of phosphate with raw limestone.

FIG. 8. is a graph showing the effect of initial pH on the removal of phosphate with the LS+Fe₂O₃+Ag composite.

FIG. 9. is a graph showing the effect of initial pH on the removal of phosphate with the LS+Fe₂O₃+Ag composite.

FIG. 10. is a graph showing the effect of initial pH on the removal of phosphate using the LS+CuO+Ag composite.

FIG. 11. is a graph showing the effect of initial pH on the removal of phosphate with the LS+ZnO+Ag composite.

FIG. 12 illustrates images showing the antibacterial properties towards E. coli bacteria of raw limestone, Fe₂O₃, CuO and ZnO nanomaterials synthesized via thermal decomposition technique.

FIG. 13 illustrates images showing the antibacterial properties towards E. coli bacteria of raw LS, LS+Fe₂O₃+Ag, LS+CuO+Ag, and LS+ZnO+Ag nanocomposites synthesized via thermal decomposition process.

FIG. 14 is a table showing the diameters of the inhibition zone of functionalized limestone composites according to an example of the present disclosure.

### DETAILED DESCRIPTION OF EXAMPLE EMBODIMENTS

The present disclosure generally relates to a functionalized limestone with antimicrobial properties, and for heavy metals and phosphate removal for wastewater treatment applications.

Many people around the world, including the residents of Qatar, may not drink the tap water provided at their residences due to concerns about quality and taste, and safety. During the flow of drinking water in the pipe network and storage in reservoirs for a long time (especially at high outside temperature in Qatar), water is exposed to bacterial growth. Moreover, there is a growing concern toward potential health risks posed by disinfection by-products (DBPs) in chlorinated drinking water. Therefore, there is a need to polish the tap water quality in terms of removal of bacteria, traces of DBPs, and heavy metals before use.

Nowadays filtration by adsorption processes is one of the most attractive methods for water treatment. Many adsorbents are available in the market, for instance activated carbon, zeolite, silica, kaolinite, bentonite, and montmorillonite. However, these adsorbents have problems, such as low sorption capacity, high price, and poor removal performance.

Limestone (LS) (calcium carbonate) or dolomite (calcium magnesium carbonate) are widely available in nature and are cost-effective materials compared to other adsorbents. LS may be used to remove sulfate from mine drainages and waste water, eliminate silica, improve the quality of drinking water in terms of softening, purifying and removing its impurities, neutralize water acidity, for improving taste, smell and color of drinking water. Limestone's price is cheap (e.g., about $12/ton) compared to the price of activated carbon (e.g., $2.7/kg). However, LS has low surface area of about 0.6 m²/g and is not capable of removing microbes and heavy metals from wastewater.

Aspects of the present disclosure may provide a limestone (LS) doped with silver (Ag) and iron oxide (Fe₂O₃)/zinc oxide (ZnO)/copper oxide (CuO). For example, aspects of the present disclosure may provide a limestone doped with zinc oxide and silver (LS—ZnO—Ag), a limestone doped with copper oxide and silver (LS—CuO—Ag), and a limestone doped with iron oxide and silver (LS-Fe₂O₃—Ag). The doped limestone according to the present disclosure may show enhanced surface area, sorption capacity, and antimicrobial properties. The doped limestone may be synthesized by a new one-step thermal decomposition method and used as an absorbent to remove heavy metals and phosphate from synthetic water and treated sewage effluents (TES).

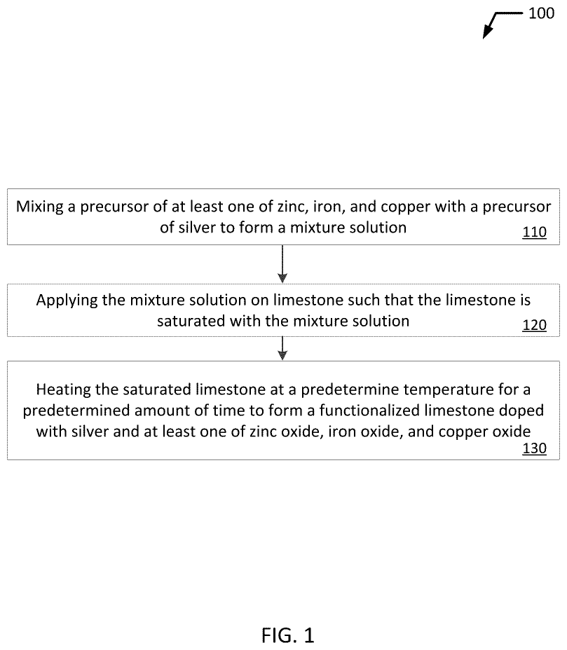

FIG. 1 is a flowchart illustrating an example method 100 for manufacturing a functionalized composite according to an example of the present disclosure. Although the example method 100 is described with reference to the flowchart illustrated in FIG. 1, it will be appreciated that many other methods of performing the acts associated with the method may be used. For example, the order of some of the blocks may be changed, certain blocks may be combined with other blocks, and some of the blocks described are optional.

In some examples, the method may include mixing a precursor of at least one of zinc, iron, and copper with a precursor of silver to form a mixture solution (block 110). For example, the two or more precursors of Zn, Cu, Fe, and Ag may be dissolved in deionized water, thereby forming a mixture solution.

In some examples, the precursor of zinc may be and/or include zinc acetate (e.g., zinc acetate dihydrate) or any other suitable zinc precursor. In some examples, the precursor of iron may be and/or include iron (III) nitrate (e.g., iron (III) nitrate 9-hydrate) or any other suitable iron precursor. In some examples, the precursor of copper may be and/or include copper (II) nitrate or any other suitable copper precursor. In some examples, the precursor of silver may be and/or include silver nitrate or any other suitable silver precursor.

Then, the mixture solution may be applied on limestone such that the limestone is saturated with the mixture solution (block 120). For example, the mixture solution may be sprayed on limestone such that the limestone is saturated with the mixture solution. In other examples, the mixture solution may be applied on limestone using any other suitable method.

Then, the saturated limestone may be heated at a predetermine temperature for a predetermined amount of time to form a functionalized limestone doped with silver and at least one of zinc oxide, iron oxide, and copper oxide (block 130). In some examples, the predetermined temperature may be in a range of about 450° C. to about 600 °C. In other examples, the predetermined temperature may have any other suitable temperature level. In some examples, the predetermined period of time may be in a range of about 0.5 hours to about 2 hours. In other examples, the predetermined period of time may have any other suitable time value.

In some examples, a weight ratio of the limestone to the at least one of zinc oxide, iron oxide, and copper oxide in the functionalized limestone may be in a range of about 99:1 to about 95:5. In some examples, a weight ratio of the limestone to the silver in the functionalized limestone may be in a range of about 99.5:0.5 to about 99:1.

In some examples, a functionalized composite according to the present disclosure may be provided. The functionalized composite may include limestone, at least one of zinc oxide, iron oxide, and copper oxide, and silver. The limestone may be doped with the silver and the at least one of zinc oxide, iron oxide, and copper oxide.

In some examples, the functionalized composite may include limestone, zinc oxide, and silver, and may not include iron oxide and copper oxide. When zinc oxide is present in the functionalized composite/limestone (without iron oxide and copper oxide), a weight ratio of the limestone to the zinc oxide in the functionalized composite/limestone may be in a range of about 99:1 to about 95:5.

In other examples, the functionalized composite may include limestone, iron oxide, and silver, and may not include zinc oxide and copper oxide. When iron oxide is present in the functionalized composite/limestone (without zinc oxide and copper oxide), a weight ratio of the limestone to the iron oxide in the functionalized composite/limestone may be in a range of about 99:1 to about 95:5.

In other examples, the functionalized composite may include limestone, copper oxide, and silver, and may not include zinc oxide and iron oxide. When copper oxide is present in the functionalized composite/limestone (without zinc oxide and iron oxide), a weight ratio of the limestone to the copper oxide in the functionalized composite/limestone may be in a range of about 99:1 to about 95:5.

In some examples, a total surface area of the functionalized composite/limestone may be greater than 0.7 m²/g, preferably, greater than 0.75 m²/g, more preferably, greater than 1.1 m²/g.

### EXAMPLES

Some example functionalized composites were prepared as discussed in more details below.

### Example 1

An example functionalized limestone (LS) doped with zinc oxide and silver was prepared. In this example, LS—ZnO—Ag composites were prepared by quick thermal decomposition of zinc acetate dihydrate (Zn(CH₃COO)₂·₂H₂O, ACS reagent, ≥99.0%, Aldrich, Fluka) and silver nitrate (AgNO₃, ≥99.0%, Sigma-Aldrich) in the presence of LS in a muffle furnace (Thermo Scientific Thermolyne 5.8 L Al Benchtop Muffle Furnace, 240V) under air atmosphere at 500° C. for 1 h. In the mixing process, 2 g of zinc acetate dehydrate and 1 g of silver nitrate was mixed and dissolved in 10 ml of deionized water (5 min stirring and 5 min sonication in an ultrasonic bath). The mixture solution was sprayed on 100 g of LS until fully absorbed by LS. The saturated LS sample then was put inside an alumina crucible and was heated at 500° C. for 1 h. After the furnace was switched off, the LS doped with iron oxide and silver sample was cooled down to room temperature and taken out of the furnace.

### Example 2

An example functionalized limestone (LS) doped with iron oxide and silver was prepared. In this example, LS-Fe₂O₃—Ag composites were prepared by quick thermal decomposition of iron (III) nitrate 9-hydrate (Fe(NO₃) 3.9H₂O) (99.99%, Aldrich, Fluka) and silver nitrate (AgNO₃, >99.0%, Sigma-Aldrich) in the presence of LS in a muffle furnace (Thermo Scientific Thermolyne 5.8 L Al Benchtop Muffle Furnace, 240V) under air atmosphere at 500° C. for 1 h. In the mixing process, 2 g of iron (III) nitrate 9-hydrate and 1 g of silver nitrate was mixed and dissolved in 10 ml of deionized water (5 min stirring and 5 min sonication in an ultrasonic bath). The mixture solution was sprayed on 100 g of LS until fully absorbed by LS. The saturated LS sample then was put inside an alumina crucible and was heated at 500° C. for 1 h. After the furnace was switched off, the LS doped with iron oxide and silver sample was cooled down to room temperature and taken out of the furnace.

### Example 3

An example functionalized limestone (LS) doped with copper oxide and silver was prepared. In this example, LS-Copper (II) nitrate-Ag composites were prepared by quick thermal decomposition of Copper (II) nitrate, (Cu(NO₃)₂·2H₂O, ACS reagent, ≥99.9%, Aldrich, Fluka) and silver nitrate (AgNO₃, ≥99.0%, Sigma-Aldrich) in the presence of LS in a muffle furnace (Thermo Scientific Thermolyne 5.8 L Al Benchtop Muffle Furnace, 240V) under air atmosphere at 500° C. for 1 h. In the mixing process, 2 g of copper (II) nitrate and 1 g of silver nitrate was mixed and dissolved in 10 ml of deionized water (5 min stirring and 5 min sonication in an ultrasonic bath). The mixture solution was sprayed on 100 g of LS until fully absorbed by LS. The saturated LS sample then was put inside an alumina crucible and was heated at 500° C. for 1 h. After the furnace was switched off, the LS doped with iron oxide and silver sample was cooled down to room temperature and taken out of the furnace.

### Example 4

The functionalized limestone composites prepared in Examples 1−3 were evaluated using various evaluation tools and techniques. For example, X-ray diffraction (XRD) method (Bruker D8 Advance X-Ray diffractometer with Cu-Kα radiation source) was used to study the structure of the synthesized materials. SEM/EDS characterization was also performed by JEOL JSM 7800F FE-SEM and Oxford Amax 80 mm² EDS microscopies. Powder samples were taken in a spatula and sprinkled onto a double-sided adhesive carbon tape, and excess powder was blown off. For SEM imaging, 5 KV acceleration voltage was used. Back Scatter Electron (BSE) imaging detector was used to show the atomic number contrast difference between Ag and ZnO. For EDS analysis, 10 KV acceleration voltage was used, which enabled to limit the excitation volume to the powder sample and avoid signals from the carbon tape and aluminum stub. The morphology of the prepared samples were studied by FE-SEM and high-resolution transmission electron microscopy (HRTEM) (FEI Talos). The surface and porous properties of raw and doped materials were determined by BET analysis with an ASAP−2020 surface analyzer. Degassing conditions were set at 200° C. for 480 min before BET measuring.

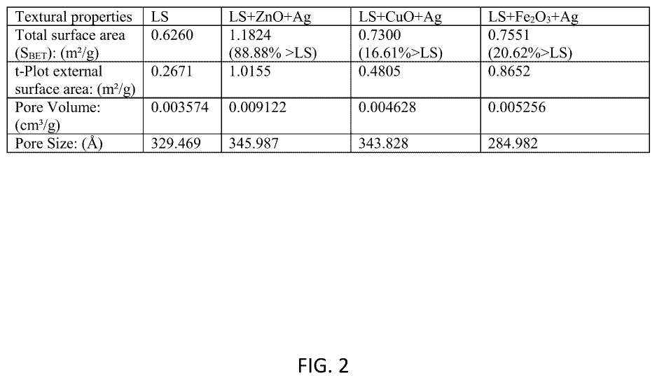

FIG. 2 shows a table summarizing the textural properties of raw limestone before doping and limestone doped with ZnO, CuO, Fe₂O₃ and Ag. The data shows that the doped samples have larger total surface area.

### Example 5

In this example, the phosphate and heavy metals removal performance of the functionalized limestone composites prepared in Examples 1−3 was evaluated. The adsorption removal of phosphate and heavy metals was performed in batch adsorption mode. The operational conditions for the phosphate adsorption experiments are as follows: initial phosphate concentration 30−20 mg/L, speed of agitation is 200 RPM, temperature 25° C. and adsorption times are 1 hour and 20 hours. The effect of dose and pH on the removal of phosphate was also studied. Samples of treated sewage effluent (TSE) spiked with phosphate were shaken by using the Grant OLS Aqua Pro temperature-controlled shaker (Model OLS26, UK). While adsorption was taking place, the samples for analysis were collected at predetermined time intervals, filtered over a 0.2 μm PES membrane filter and phosphate content was analyzed by an ion chromatography (ICS−5000+, Dionex, Thermo Fisher Scientific, USA) using a Guard Column type AG19 2× 250 mm and Separator Columntype AS19 2× 250 mm. The phosphate analytical standard was used for IC calibration and quantification. A calibration curve was prepared by analyzing standards of known phosphate concentrations to ensure the accuracy of the measurements.

The phosphate and heavy metals removal (%) were calculated using the following equation:

$$X removal ( \% ) = \frac{100 ( {C}_{0} - {C}_{e} )}{{C}_{0}} \qquad ( Equation 1 )$$

Where X is phosphate or heavy metals and Co and Ce are the initial and equilibrium concentrations of phosphate or heavy metals (in mg/L).

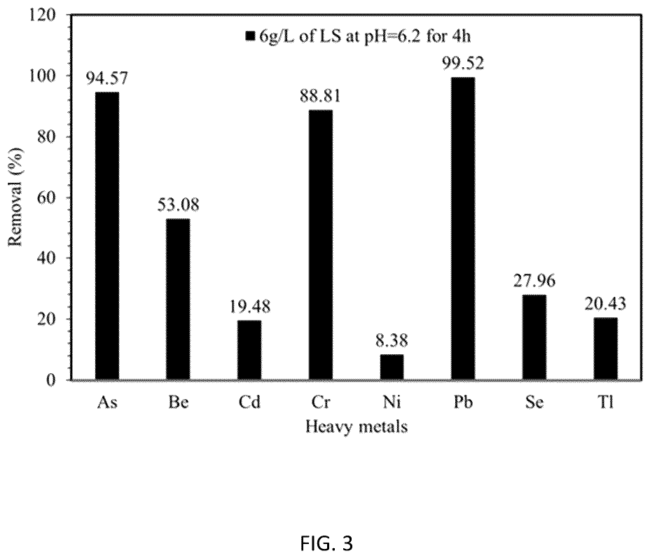

Removal of heavy metals (As, Be, Cd, Cr, Ni, Pb, Se and Tl) from polycomponent solution with raw limestone and doped limestone were studied in batch adsorption mode. Adsorption conditions are as follows: initial heavy metals concentration 1.1 mg/L, speed of agitation 150 RPM, temperature 25° C., pH=6.2±0.3, adsorption time 4 hours and adsorbent dose 6 g/L. The results of phosphate and heavy metals removal by raw limestone and limestone doped materials are shown in FIGS. 3 to 11.

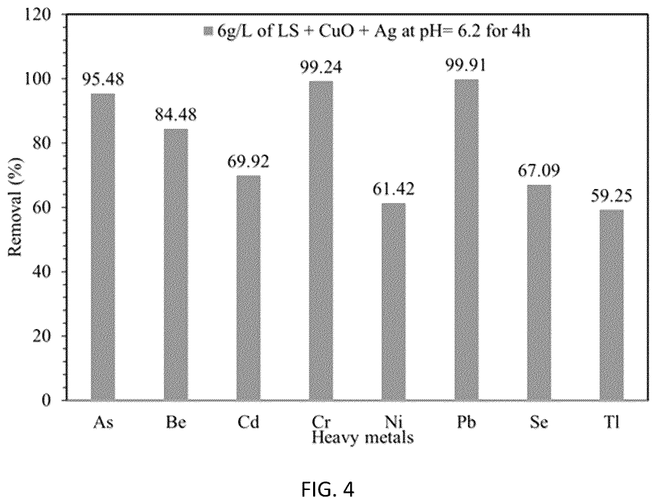

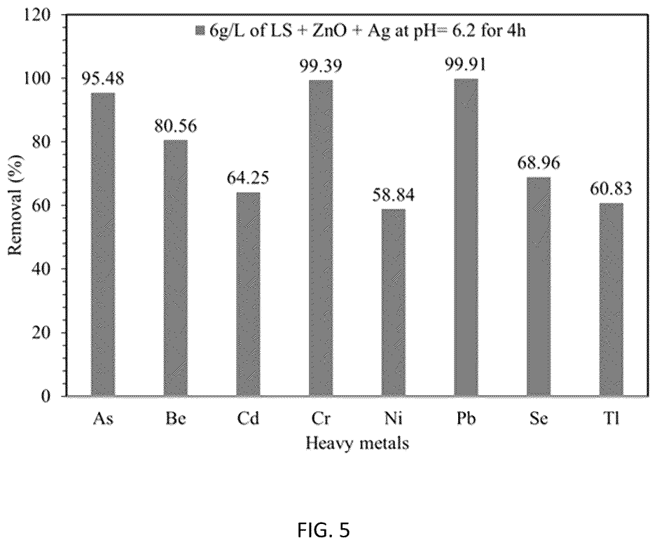

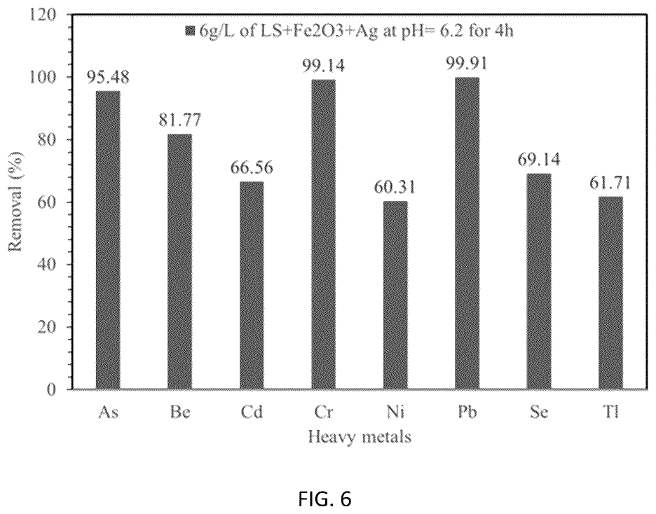

For example, FIG. 3 is a graph showing the removal of heavy metals (As, Be, Cd, Cr, Ni, Pb, Se and Tl) from polycomponent solution with raw limestone. Adsorption conditions are as follows: initial metals concentration 1.1 mg/L, speed of agitation 150 RPM, temperature 25° C., pH=6.2±0.3, adsorption time 4 h and adsorbent dose 6 g/L. FIG. 4. is a graph showing the removal of heavy metals (As, Be, Cd, Cr, Ni, Pb, Se and Tl) from polycomponent solution with limestone doped with CuO and Ag. Adsorption conditions are as follows: initial heavy metals concentration 1.1 mg/L, speed of agitation 150 RPM, temperature 25° C., pH=6.2±0.3, adsorption time 4 h and adsorbent dose 6 g/L. FIG. 5. is a graph showing the removal of heavy metals (As, Be, Cd, Cr, Ni, Pb, Se and Tl) from polycomponent solution with limestone doped with ZnO and Ag. Adsorption conditions are as follows: initial multi-heavy metals concentration 1.1 mg/L, speed of agitation 150 RPM, temperature 25° C., pH=6.2±0.3, adsorption time 4 h and adsorbent dose 6 g/L. FIG. 6. is a graph showing the removal of heavy metals (As, Be, Cd, Cr, Ni, Pb, Se and Tl) from polycomponent solution with limestone doped with Fe₂O₃ and Ag. Adsorption conditions are as follows: initial multi-heavy metals concentration 1.1 mg/L, speed of agitation 150 RPM, temperature 25° C., pH=6.2±0.3, adsorption time 4 h and dose 6 g/L.

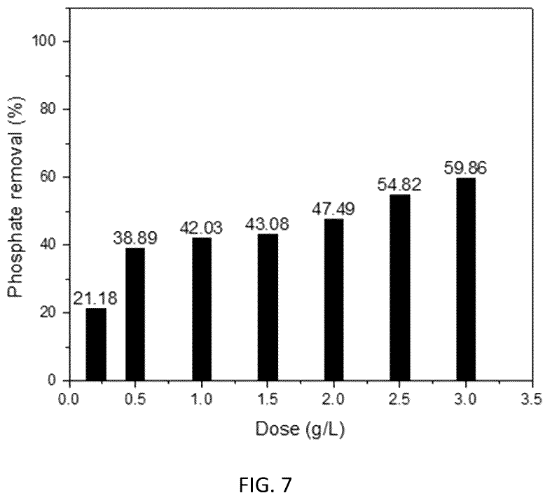

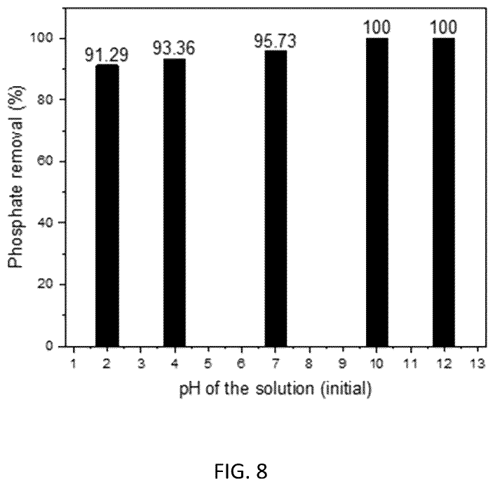

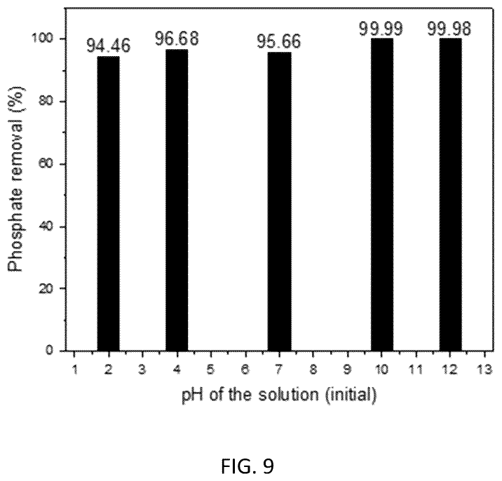

FIG. 7. is a graph showing the effect of dose on the removal of phosphate with raw limestone. Adsorption conditions are as follows: initial phosphate concentration 20 mg/L, speed of agitation 200 RPM, temperature 25° C., pH=7.5±0.3. FIG. 8. is a graph showing the effect of initial pH on the removal of phosphate with the LS+Fe₂O₃+Ag composite. Adsorption conditions are as follows: initial phosphate concentration 30 mg/L, speed of agitation 200 RPM, temperature 25° C., adsorption time 1 h and dose 3 g/L. FIG. 9. is a graph showing the effect of initial pH on the removal of phosphate with the LS+Fe₂O₃+Ag composite. Adsorption conditions are as follows: initial phosphate concentration 30 mg/L, speed of agitation 200 RPM, temperature 25° C., adsorption time 20 h and dose 3 g/L.

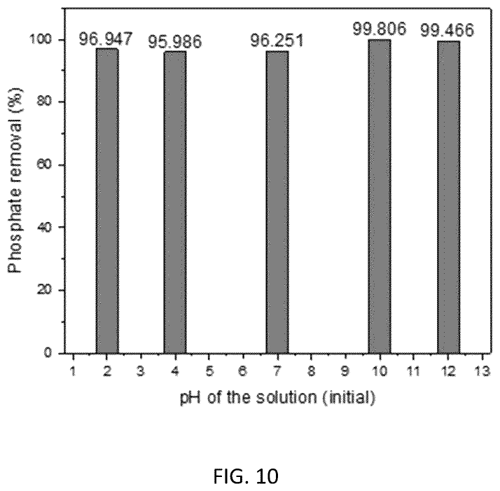

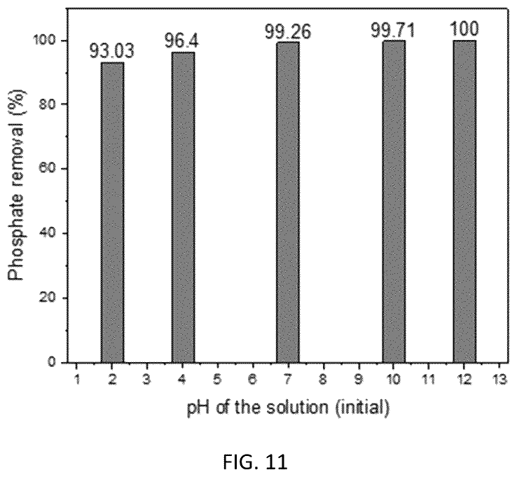

FIG. 10. is a graph showing the effect of initial pH on the removal of phosphate using the LS+CuO+Ag composite. Adsorption conditions are as follows: the initial phosphate concentration 30 mg/L, speed of agitation 200 RPM, temperature 25° C., adsorption time 20 h and dose 3 g/L. FIG. 11. is a graph showing the effect of initial pH on the removal of phosphate with the LS+ZnO+Ag composite. Adsorption conditions are as follows: initial phosphate concentration 30 mg/L, agitation speed 200 RPM, temperature 25° C., adsorption time 20 h and dose 3 g/L.

As shown in FIGS. 3 to 11, the functionalized limestone composites according to the present disclosure generally show a better phosphate and heavy metal removal performance compared to the raw limestone.

### Example 6

In this example, antibacterial properties of the functionalized limestone composites prepared in Examples 1−3 were evaluated and compared with the antibacterial properties of raw limestone, Fe₂O₃, ZnO and CuO. The antibacterial properties of these samples towards E. coli bacteria were studied by evaluating the inhibition zone around the tested materials. E-coli was used as G-negative bacteria in this study.

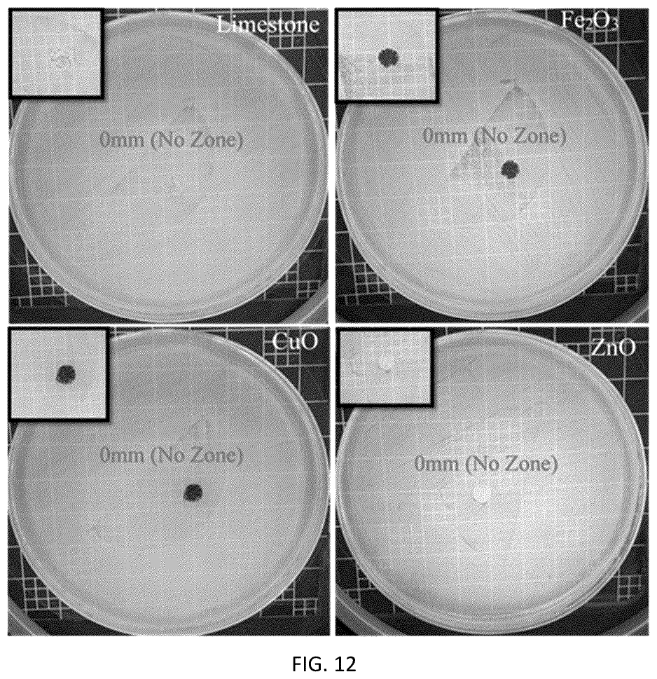

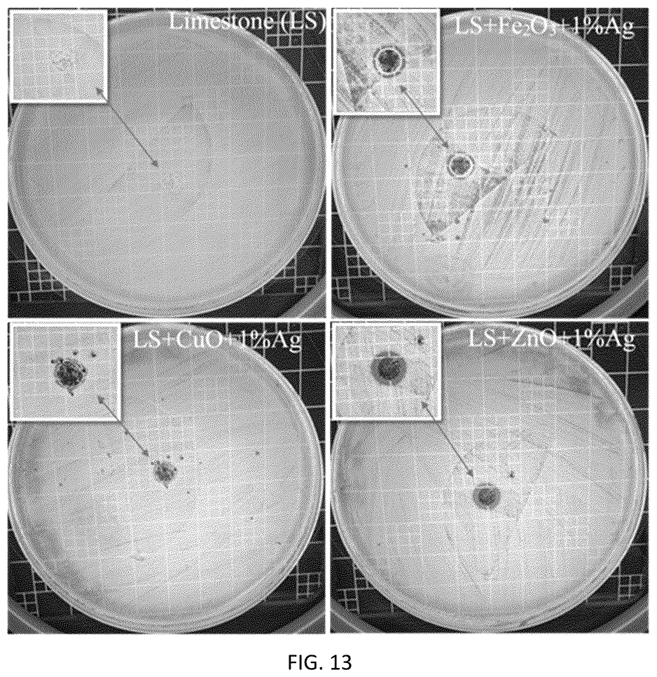

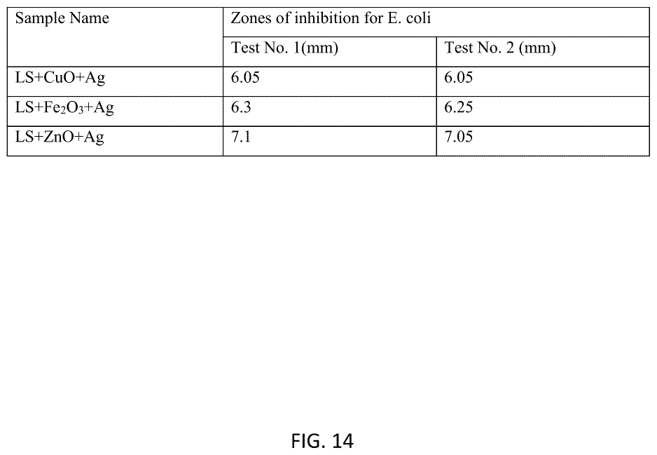

FIG. 12 illustrates images showing the antibacterial properties towards E. coli bacteria of raw limestone, Fe₂O₃, CuO and ZnO nanomaterials synthesized via thermal decomposition technique. FIG. 13 illustrates images showing the antibacterial properties towards E. coli bacteria of raw LS; LS+Fe₂O₃+Ag, LS+CuO+Ag, and LS+ZnO+Ag nanocomposites synthesized via thermal decomposition process. As shown in FIGS. 12 and 13, the bacterial inhibition zones are lacking for raw LS, Fe₂O₃, ZnO and CuO. On the other hand, the inhibition zones for LS—CuO—Ag, LS-Fe₂O₃—Ag and LS—ZnO—Ag composites against the used bacterial strains are visible. FIG. 14 is a table showing the diameters of the inhibition zone of the functionalized limestone composites prepared in Examples 1−3 for E. coli. It was shown that increasing of Ag loading from 0.3 to 1 wt. % leads to significant improvement of the antibacterial properties. FIG. 14 shows that the sample of LS doped with ZnO and Ag has higher bactericidal effect than Fe₂O₃ and CuO doped in the LS composite samples.

### EMBODIMENTS

Various aspects of the subject matter described herein are set out in the following numbered embodiments:

Embodiment 1. A method of manufacturing a functionalized composite includes mixing a precursor of at least one of zinc, iron, and copper with a precursor of silver to form a mixture solution, applying the mixture solution on limestone such that the limestone is saturated with the mixture solution, and heating the saturated limestone at a predetermine temperature for a predetermined amount of time to form a functionalized limestone doped with silver and at least one of zinc oxide, iron oxide, and copper oxide.

Embodiment 2. The method of embodiment 1, wherein the precursor of at least one of zinc, iron, and copper comprises zinc acetate.

Embodiment 3. The method of embodiment 1, wherein the precursor of at least one of zinc, iron, and copper comprises iron (III) nitrate.

Embodiment 4. The method of embodiment 1, wherein the precursor of at least one of zinc, iron, and copper comprises copper (II) nitrate.

Embodiment 5. The method of any one of embodiments 1−4, wherein the precursor of silver comprises silver nitrate.

Embodiment 6. The method of any one of embodiments 1−5, wherein the predetermined temperature is in a range of about 450° C. to about 600 °C.

Embodiment 7. The method of any one of embodiments 1−6, wherein the predetermined period of time is in a range of about 0.5 hours to about 2 hours.

Embodiment 8. The method of any one of embodiments 1−7, wherein a weight ratio of the limestone to the at least one of zinc oxide, iron oxide, and copper oxide in the functionalized limestone is in a range of about 99:1 to about 95:5.

Embodiment 9. The method of any one of embodiments 1−8, wherein a weight ratio of the limestone to the silver in the functionalized limestone is in a range of about 99.5:0.5 to about 99:1.

Embodiment 10. The method of any one of embodiments 1−9, wherein a total surface area of the functionalized limestone is greater than 0.7 m²/g.

Embodiment 11. A method of manufacturing a functionalized composite comprises mixing a precursor of at least one of zinc, iron, and copper with a precursor of silver to form a mixture solution, applying the mixture solution on limestone such that the limestone is saturated with the mixture solution, heating the saturated limestone at a predetermine temperature for a predetermined amount of time to form a functionalized limestone doped with silver and at least one of zinc oxide, iron oxide, and copper oxide, wherein the predetermined temperature is in a range of about 450° C. to about 600° C., and wherein the predetermined period of time is in a range of about 0.5 hours to about 2 hours.

Embodiment 12. The method of embodiment 11, wherein a weight ratio of the limestone to the at least one of zinc oxide, iron oxide, and copper oxide in the functionalized limestone is in a range of about 99:1 to about 95:5.

Embodiment 13. The method of any one of embodiments 11−12, wherein a weight ratio of the limestone to the silver in the functionalized limestone is in a range of about 99.5:0.5 to about 99:1.

Embodiment 14. A functionalized composite comprises limestone, at least one of zinc oxide, iron oxide, and copper oxide, and silver, wherein the limestone is doped with the silver and the at least one of zinc oxide, iron oxide, and copper oxide.

Embodiment 15. The method of embodiment 14, wherein the at least one of zinc oxide, iron oxide, and copper oxide comprises the zinc oxide.

Embodiment 16. The method of embodiment 14, wherein the at least one of zinc oxide, iron oxide, and copper oxide comprises the copper oxide.

Embodiment 17. The method of embodiment 14, wherein the at least one of zinc oxide, iron oxide, and copper oxide comprises the iron oxide.

Embodiment 18. The method of any one of embodiments 14−17, wherein a weight ratio of the limestone to the at least one of zinc oxide, iron oxide, and copper oxide in the functionalized composite is in a range of about 99:1 to about 95:5.

Embodiment 19. The method of any one of embodiments 14−18, wherein a weight ratio of the limestone to the silver in the functionalized composite is in a range of about 99.5:0.5 to about 99:1.

Embodiment 20. The method of any one of embodiments 14−19, wherein a total surface area of the functionalized composite is greater than 0.7 m²/g.

As shown above, the functionalized limestone/composite according to the present disclosure may possess strong antibacterial properties and are beneficial for removal of heavy metals and DBPs from water. The functionalized limestone/composite according to the present disclosure can be used as novel adsorbents and additives to polymeric/ceramic membranes in water treatment for removal of bacteria, DBPs, heavy metals, turbidity and particular matter particles from water, taste & odor improvement. The functionalized limestone/composite according to the present disclosure can be also used as a paint for concrete tanks and dams to prevent biological corrosion.

As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

Reference throughout the specification to “various aspects,” “some aspects,” “some examples,” “other examples,” “some cases,” or “one aspect” means that a particular feature, structure, or characteristic described in connection with the aspect is included in at least one example. Thus, appearances of the phrases “in various aspects,” “in some aspects,” “certain embodiments,” “some examples,” “other examples,” “certain other embodiments,” “some cases,” or “in one aspect” in places throughout the specification are not necessarily all referring to the same aspect. Furthermore, the particular features, structures, or characteristics illustrated or described in connection with one example may be combined, in whole or in part, with features, structures, or characteristics of one or more other aspects without limitation.

It is to be understood that at least some of the figures and descriptions herein have been simplified to illustrate elements that are relevant for a clear understanding of the disclosure, while eliminating, for purposes of clarity, other elements. Those of ordinary skill in the art will recognize, however, that these and other elements may be desirable. However, because such elements are well known in the art, and because they do not facilitate a better understanding of the disclosure, a discussion of such elements is not provided herein.

The terminology used herein is intended to describe particular embodiments only and is not intended to be limiting of the present disclosure. As used herein, the singular forms “a,” “an,” and “the” are intended to include the plural forms as well, unless otherwise indicated. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “at least one of X or Y” or “at least one of X and Y” should be interpreted as X, or Y, or X and Y.

It should be understood that various changes and modifications to the examples described herein will be apparent to those skilled in the art. Such changes and modifications can be made without departing from the spirit and scope of the present subject matter and without diminishing its intended advantages. It is therefore intended that such changes and modifications be covered by the appended claims.

1. A method of manufacturing a functionalized composite, the method comprising:
mixing a precursor of at least one of zinc, iron, and copper with a precursor of silver to form a mixture solution;
applying the mixture solution on limestone such that the limestone is saturated with the mixture solution;
heating the saturated limestone at a predetermine temperature for a predetermined amount of time to form a functionalized limestone doped with silver and at least one of zinc oxide, iron oxide, and copper oxide.

2. The method of claim 1, wherein the precursor of at least one of zinc, iron, and copper comprises zinc acetate.

3. The method of claim 1, wherein the precursor of at least one of zinc, iron, and copper comprises iron (III) nitrate.

4. The method of claim 1, wherein the precursor of at least one of zinc, iron, and copper comprises copper (II) nitrate.

5. The method of claim 1, wherein the precursor of silver comprises silver nitrate.

6. The method of claim 1, wherein the predetermined temperature is in a range of about 450° C. to about 600 °C.

7. The method of claim 1, wherein the predetermined period of time is in a range of about 0.5 hours to about 2 hours.

8. The method of claim 1, wherein a weight ratio of the limestone to the at least one of zinc oxide, iron oxide, and copper oxide in the functionalized limestone is in a range of about 99:1 to about 95:5.

9. The method of claim 1, wherein a weight ratio of the limestone to the silver in the functionalized limestone is in a range of about 99.5:1 to about 99:1.

10. The method of claim 1, wherein a total surface area of the functionalized limestone is greater than 0.7 m²/g.

11. A method of manufacturing a functionalized composite, the method comprising:
mixing a precursor of at least one of zinc, iron, and copper with a precursor of silver to form a mixture solution;
applying the mixture solution on limestone such that the limestone is saturated with the mixture solution;
heating the saturated limestone at a predetermine temperature for a predetermined amount of time to form a functionalized limestone doped with silver and at least one of zinc oxide, iron oxide, and copper oxide,
wherein the predetermined temperature is in a range of about 450° C. to about 600° C., and
wherein the predetermined period of time is in a range of about 0.5 hours to about 2 hours.

12. The method of claim 11, wherein a weight ratio of the limestone to the at least one of zinc oxide, iron oxide, and copper oxide in the functionalized limestone is in a range of about 99:1 to about 95:5.

13. The method of claim 11, wherein a weight ratio of the limestone to the silver in the functionalized limestone is in a range of about 99.5:0.5 to about 99:1.

14. A functionalized composite comprising:
limestone;
at least one of zinc oxide, iron oxide, and copper oxide; and
silver,
wherein the limestone is doped with the silver and the at least one of zinc oxide, iron oxide, and copper oxide.

15. The functionalized composite of claim 14, wherein the at least one of zinc oxide, iron oxide, and copper oxide comprises the zinc oxide.

16. The functionalized composite of claim 14, wherein the at least one of zinc oxide, iron oxide, and copper oxide comprises the copper oxide.

17. The functionalized composite of claim 14, wherein the at least one of zinc oxide, iron oxide, and copper oxide comprises the iron oxide.

18. The functionalized composite of claim 14, wherein a weight ratio of the limestone to the at least one of zinc oxide, iron oxide, and copper oxide in the functionalized composite is in a range of about 99:1 to about 95:5.

19. The functionalized composite of claim 14, wherein a weight ratio of the limestone to the silver in the functionalized composite is in a range of about 99.5:0.5 to about 99:1.

20. The functionalized composite of claim 14, wherein a total surface area of the functionalized composite is greater than 0.7 m²/g.
